(19) United States
(12) Patent Application Publication
(10) Pub. No.: US 2009/0205319 A1
(43) Pub. Date: Aug. 20, 2009

(54) Ammonia Precursor Storage System

(75) Inventors: Francois Dougnier, Boortmeerbeek (BE); Joel Op De Beeck, Lint (BE); Vincent Potier, Brussels (BE); Jules-Joseph Van Schaftingen, Wavre (BE)

Correspondence Address: Solvay;c/o B. Ortego - IAM-NAFTA, 3333 Richmond Avenue, Houston, TX, 77098-3099, US

(73) Assignee: INERGY AUTOMOTIVE SYSTEMS RESEARCH, Brussels (BE)

(21) Appl. No.: 12/307,940

(22) PCT Filed: Jul. 10, 2007
(86) PCT No.: PCT/EP07/57002

§ 371 Date: Jan. 8, 2009

(30) Foreign Application Priority Data
Jul. 12, 2006 (FR) 0606398

(51) Int. Cl. F01N 3/20; F16K 24/04

(52) U.S. Cl. 60/282; 137/171

(57) ABSTRACT

A system for storing an ammonia precursor, comprising a tank, a filler pipe equipped With an obturator and a ventilation line establishing a direct connection between the filler pipe and a gas discharge duct and also a device designed to specifically open this connection once the obturator starts to be opened.

The present application relates to a storage system for an ammonia precursor (in particular, an aqueous urea solution), for example intended to be injected into the exhaust line of an internal combustion engine.

Legislation on vehicle and heavy goods vehicle emissions stipulates, amongst others, a reduction in the release of nitrogen oxides NOx into the atmosphere. One known way to achieve this objective is to use the SCR (Selective Catalytic Reduction) process which enables the reduction of nitrogen oxides by injection of a reducing agent, generally ammonia, into the exhaust line. This ammonia may derive from the pyrolytic decomposition of an ammonia precursor solution, whose concentration may be the eutectic concentration. Such an ammonia precursor is generally a urea solution.

With the SCR process, the high levels of NOx produced in the engine during combustion at optimized efficiency are treated in a catalyst on exiting the engine. This treatment requires the use of the reducing agent at a precise concentration and of extreme quality. The solution is thus accurately metered and injected into the exhaust gas stream where it is hydrolysed before converting the nitrogen oxide (NOx) to nitrogen (N₂) and water (H₂O).

In order to do this, it is necessary to equip the vehicles with a tank containing an aqueous urea solution and also a device for metering and injecting the desired amount of additive into the exhaust line.

Several systems for storing and supplying urea solutions have been provided in the prior art. Some of these systems have even been designed to eliminate the effects relating to the decomposition of the urea solution on board, which under the action of heat leads to release of ammonia and carbon dioxide in larger amounts when the temperature to which the solution is raised is higher. The ammonia fumes could indeed promote corrosion phenomena and be a source of olfactory irritation due to the irritant character of this gas, whose detection threshold lies between 0.5 and 37 mg/m³ of air.

Application JP 2003/314252 describes a urea storage system comprising a tank and a canister that enables the ammonia vapours generated in the tank to be adsorbed before releasing the pressurized gases, generated above the urea solution in the sealed tank, to the atmosphere.

Application US 2006/0051276 discloses a system for adsorbing these vapours comprising a washing bottle containing water, and a safety valve.

In each of these systems, the tank is pressurized (in order to limit releases of ammonia) and it is only ventilated above a certain threshold pressure. Therefore, a puff of ammonia may be generated during opening of the tank fill pipe, which is unpleasant for the person carrying out the filling, and releases corrosive gases which, after several fills, may damage the neighbouring structures.

Document U.S. Pat. No. 5,964,204 describes a system connecting a fuel tank ventilation line that leads to a canister with a condensation tube that is itself in contact with the filler pipe. This system is specific to fuel tanks where the condensed vapours are composed of fuel and which it is therefore advantageous to convey to the tank rather than risk discharging them during filling.

Such a system still has a risk of releasing a puff of gas after opening the obturator due to the fact that there is no direct connection between the ventilation line and the inside of the tank once the obturator starts to be opened. With urea tanks the condensed vapours are mainly composed of water but, on the other hand, the “free” vapours are mainly composed of ammonia. These vapours cannot be condensed and therefore can only escape from the tank when the obturator is removed. However, if they escape freely into the atmosphere they can lead to irritation and corrosion problems.

The present application aims at solving these problems by providing a storage system for ammonia precursor solutions where the release of a puff of ammonia during filling is avoided. According to one preferred variant, all release of ammonia to the atmosphere is avoided.

For this purpose, the present invention relates to a system for storing an ammonia precursor, said system comprising a tank, a filler pipe equipped with an obturator and a ventilation line establishing a direct connection between the filler pipe and a gas discharge duct and also a device designed to specifically open this connection once the obturator starts to be opened.

The aim of the discharge duct is to prevent the “vertical” release of a puff of ammonia during filling. For this purpose, this duct diverts the ammonia vapours and deflects them from the face of the operator carrying out the filling. Preferably, the duct for discharging gases leads to a canister capable of adsorbing the ammonia vapours generated in the tank.

The present invention therefore relates to a storage system for aqueous urea solutions. Given the foregoing, the term “aqueous urea solution” is in fact understood to mean any ammonia precursor to which the present invention may apply. Eutectic solutions of urea (comprising 32.5% by weight of urea in water) are well suited in the scope of the invention.

These solutions may be intended to be injected into the exhaust gases of any internal combustion engine likely to generate NOx in its exhaust gases. It may be an engine with or without a fuel return line (that is to say, a line returning the surplus fuel not consumed by the engine to the fuel tank). The invention is advantageously applied in the context of pollution control of diesel engines, and in particular vehicle diesel engines and particularly preferably diesel engines of heavy goods vehicles.

The system according to the invention comprises at least one tank intended for storing the urea solution. This tank may be made from any material, preferably one that is chemically resistant to the additive in question. In general, this is metal or plastic. Polyolefin resins, in particular polyethylene (and more particularly HDPE or high-density polyethylene), constitute preferred materials.

The tank of the system according to the invention comprises a filler pipe that is, in a known manner, equipped with an obturator. This may be a simple cap that is removed manually by rotating (and/or spiral movement); it may also be an obturator that retracts automatically for filling, either by means of a specific actuator (push button, for example) or by means of thrust using the filling nozzle.

The tank according to the invention is preferably equipped with a ventilation line that leads into its upper wall (or even into the top of the filler pipe) and which enables the pressurized gases above the stored solution to be discharged to the canister.

Preferably, this line comprises at least one calibrated valve in order to be able to ventilate the tank (i.e. in order to discharge the pressurized gases by conveying them to the canister) above a certain pressure (generally greater than or equal to 200 mbar, even 400 mbar, but preferably less than or equal to 800 mbar, even 600 mbar). In order to do this it is possible, for example, to use a pressure/vacuum relief valve equipped with two spring valves, one limiting excess pressure inside the tank, the other admitting an inlet of air in case of a vacuum. Alternatively, it is possible to use two separate valves respectively providing the roles of pressure and vacuum relief.

This valve may be located between the canister and its connection to the atmosphere, or between the tank and the canister. The latter variant is preferred as it makes it possible to limit the amount of vapours to be adsorbed. In this case, the valve in question is preferably located near the place where the ventilation line leads into the tank. According to one particularly preferred variant of the invention, this place is located at the top of the filler pipe and the calibrated valve is integrated into the obturator. It is therefore removed or retracted while the tank is being filled. In a particularly preferred manner, this valve is by-passed, once the obturator starts to be opened, by a route automatically connecting the inside of the tank and the ventilation line. This by-pass route may be integrated into the obturator either completely or partly, the other part then being advantageously integrated into an intermediate part (ring or insert: see below and in the figures enclosed in the present document) attached to the filler pipe, and preferably to the top of the pipe. This way of proceeding especially has the advantage that the filler pipe may be standard and that it suffices to equip it with a particular obturator, optionally accompanied by an intermediate part, in order to be able to ventilate the tank effectively before filling it. This variant is therefore well suited to the manufacture (for example by extrusion-blow moulding), in series, of ammonia precursor tanks and/or to “retrofitting” (adapting) existing tanks.

The system according to the invention preferably comprises a canister or box containing a substance capable of adsorbing the ammonia vapours. These are preferably porous solids having a high specific surface area (modified activated carbons, zeolites, molecular sieves, oxides of metals, vanadium, titanium, but also silica-aluminas). Such a canister is generally connected, on one side, to the ventilation line and, on the other side, to the atmosphere.

The system according to the invention is designed to divert the vapours present in the tank and preferably to convey them to the canister just before the tank is filled, regardless of the pressure therein, and this being from when the obturator starts to be opened, as explained previously. In order to do this, it comprises a connection between the tank and the canister, and also a device that usually closes this connection (pressurizing the tank) but that opens it once the obturator starts to be opened in order to free the access to the filler pipe of the tank. The connection with the tank occurs via a ventilation line that leads into the filler pipe (in particular, into the top of it) and this connection is direct, i.e. the ventilation line leads directly into the filler pipe (via a simple orifice or via a direct connection (coupling, pipette, etc.)). In a most particularly preferred manner, the device according to the invention also comprises a device enabling the vapours present in the tank to be conveyed to the canister while the tank is being filled.

The device enabling the connection between the tank and the canister to be opened or closed generally comprises a mobile part whose movement may be controlled by a specific actuator (of “push button” type, for example). An advantageous way of producing this in practice consists in equipping the obturator with a locking mechanism having an actuator which also controls (besides the (un)locking) the movement of the mobile part.

Thus, for example, a simple key turn or press of a switch may make it possible, at the same time, to open the connection between the tank and the canister (for example, by opening a guillotine present at the inlet of the ventilation line described previously) and to unlock the mechanism so that it is possible to remove the cap or make the “automatic” obturator swing away.

In the case where the system according to the invention is intended for a vehicle having an on-board computer (see below), this computer could also, with input from the driver or garage mechanic, be made to both unlock the system and move the mobile part in order to ventilate before opening.

Alternatively, at least one part of the device may be integrated into a mobile part already present in the system, for example into the obturator itself or into a part making up part of the obturator. This variant is well suited in the case of an obturator integrating a calibrated valve, as described previously.

One way of realizing this in practice, which gives good results, consists in surrounding the valve with a chamber equipped with two orifices leading into the filler pipe: one in the lower part of the chamber and one in its upper part; and in that the filler pipe also comprises at least two orifices: one (the lower one) borne by an intermediate part (perforated insert or ring, for example) and allowing the valve to be by-passed, and the other (the upper one) being the orifice through which the ventilation line leads into the filler pipe, the two lower orifices of the chamber and of the intermediate part respectively possibly being aligned by rotating (manually or automatically) the obturator from the start of its opening, and the upper orifices of the chamber and of the pipe respectively being aligned or connected at both when the obturator is in place, in order to be able to ventilate the tank during operation, and at the start of the obturator's opening, in order to be able to ventilate the tank just before filling.

Suitable design of the cap however makes it possible in some cases to get rid of the use of the intermediate part (insert or ring). This may occur, for example, by integrating the aforementioned intermediate part into the cap or, in other words: by providing the cap with a route for by-passing the valve which is activated by rotating the cap for the purpose of removing it from the pipe.

Several variants are possible, depending on whether the valve itself is mobile or comprises a mobile component.

If the valve comprises a mobile component (valve or type of float) which respectively frees or covers the aforementioned lower orifices depending on the pressure in the tank, it is possible to provide a mechanism for by-passing this valve which becomes active just before opening of the filler pipe, for example during the start of the lid rotating. Thus, the obturator may comprise a conduit located outside the volume of the valve and equipped with two ends which may be aligned with the orifices in the filler pipe by (manually or automatically) rotating the obturator from the start of the latter opening.

If however the whole valve is mobile and rises depending on the pressure in the tank, the design may be simplified. It is sufficient to make sure that the lower orifices of the valve and of the intermediate part only coincide after rotating the obturator into the open position, the orifice in the pipe usually being sealed when the valve rests on the intermediate part, and being released when it rises in the case of overpressure in the tank, or when the obturator has turned to automatically align the orifices. It is sufficient to size and position the side openings suitably so that they at least partially connect both when the valve rises or is turned with the obturator in order to open the latter.

Note that according to one particularly advantageous variant, the design of the filler pipe and the place where the ventilation ends into it are such that while the tank is being filled the ventilation is also active. This may be achieved, for example, by making sure that the filler nozzle, once in place, frees (or rather: does not seal) the orifice through which the ventilation line leads into the pipe.

As described in a co-pending patent application in the name of the Applicant, the system according to the invention is preferably provided with a device enabling the canister to be purged, preferably by means of a purge gas. This gas may be air or exhaust gases. Purging using exhaust gases is preferred, as the effectiveness of the purge is improved by the high temperature of the gases.

The present invention also relates to an automotive vehicle equipped with a system as described previously.

In this vehicle, control of the purge cycles is preferably provided automatically by a computer which may be specific to the control of the urea storage and injection system. It may also be entrusted to a computer that is already on board the vehicle, such as the engine control unit (ECU) or the fuel system control unit (FSCU). In this case, preferably the ECU or FSCU manage the whole of the SCR function.

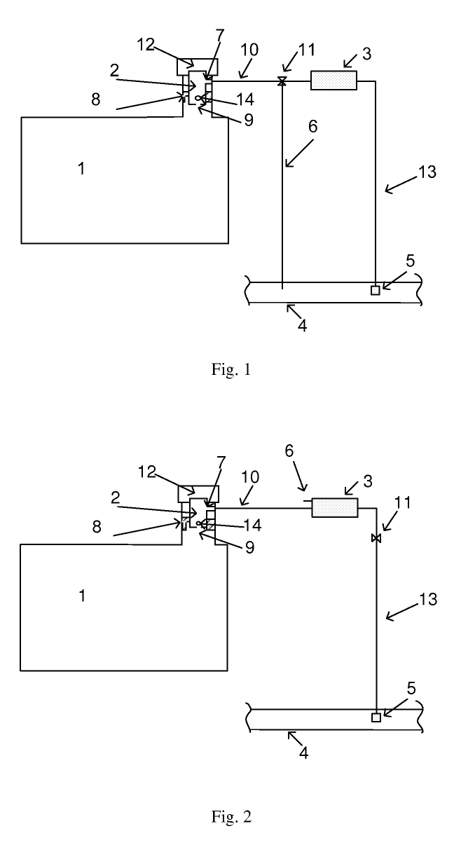

The present invention is illustrated, in a non-limiting manner, by FIGS. 1 to 5.

FIG. 1 represents a urea storage system integrating certain variants described above, and of which the purge is carried out by means of exhaust gases and

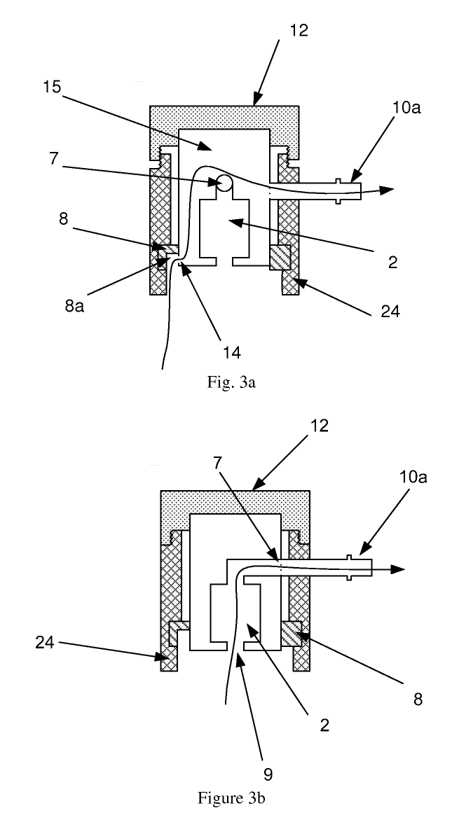

FIG. 2 represents such a system where the purge is carried out by air. These two figures illustrate a same variant of the device allowing ventilation just before filling.

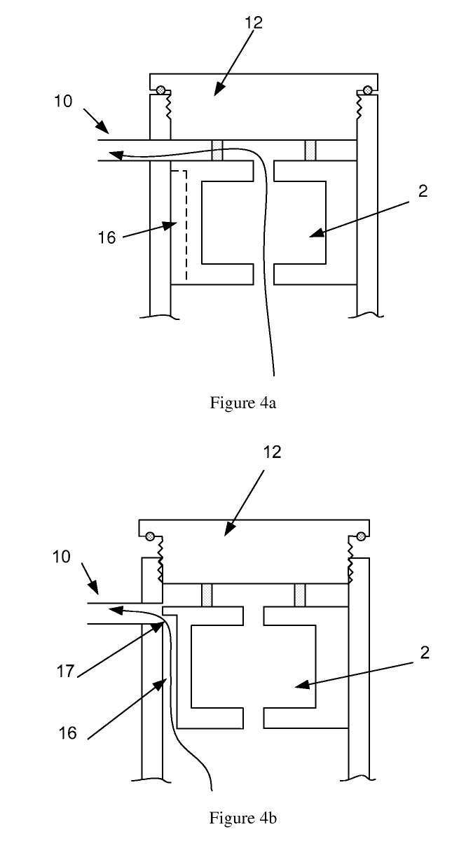

FIG. 3 represents in detail the device allowing the ventilation, just before filling, of the systems represented in FIGS. 1 and 2, using a ring-shaped intermediate part.

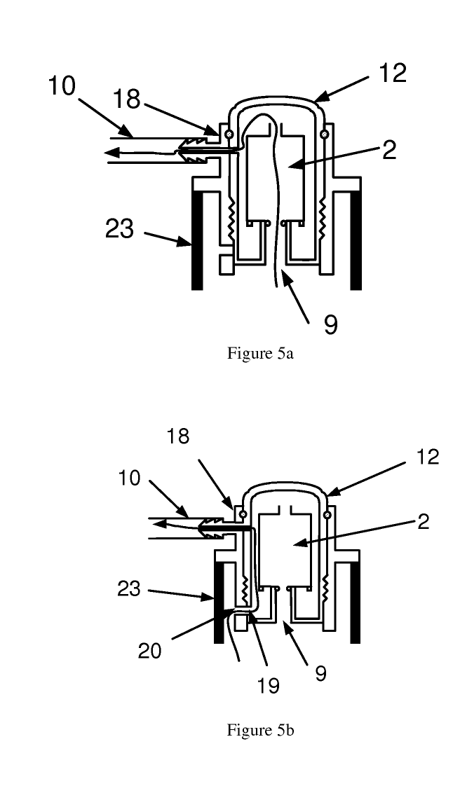

FIG. 4 shows a device allowing ventilation of the tank and degassing before filling without an intermediate part between the pipe and the cap.

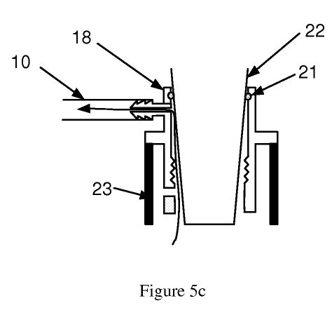

FIG. 5 illustrates a device that also includes the function of ventilation during filling, and which uses a welded insert as an intermediate part.

In these figures identical numbers denote identical or similar components.

It is possible to see therein a tank (1) equipped with a ventilation line (10) that leads into the top of the filler pipe, and a valve (2) set to 500 mbar to allow an overpressure to be maintained in the tank (1). This valve (2) is integrated into a cap (12) and it comprises a first orifice (9) that connects to the tank (1) (via its fill pipe) and a second orifice (7) that connects to the inlet of the ventilation line (10) when the cap is closed. Under the effect of a pressure that is at least equal to 500 mbar, a mobile component in the valve (or the valve itself) rises and connects the tank with the ventilation line. A gas flow is then conveyed through the orifice (9) in the valve (2) and via the ventilation line (10) to a canister (3) in which the ammonia is adsorbed.

The outlet of this canister is connected to the exhaust line (4) of the engine by a purge line (13), and the inlet of the canister is connected either to the exhaust line by a line (6) through a valve (11) (FIG. 1), or to the atmosphere via a nozzle (6) (FIG. 2).

In the system of FIG. 1, the valve (11) is provided in the ventilation line (10) to isolate the tank (1) during purging of the canister (3). During the adsorption process (both during operation and filling), the valve (11) opens the ventilation line.

In this system, regeneration of the canister (3) takes place by flushing with the exhaust gases. The valve (11) is then in a position where it seals the ventilation line (10). A fraction of the exhaust gases is then sucked through the canister via an injection line (6) by a Venturi type device (5) installed in the exhaust line (4).

In the system of FIG. 2, regeneration of the canister is provided by flushing with air and the valve (11) is placed in the purge line (13). During the purge, the valve (11) is in the open position; air enters into the filter by the nozzle (6), being sucked through the canister (3) and the purge line (13) by a Venturi type device (5) installed in the exhaust line.

The two systems (that of FIG. 1 and that of FIG. 2) are arranged to ventilate just before filling, regardless of the pressure in the tank (1). Ammonia escaping via the line (10) is also adsorbed in the canister (3) at the end of this operation.

In order to do this, as shown in FIG. 3a, during opening of the cap (12) for filling, the possible overpressure inside the tank is released when the orifice (14) of the chamber (15) making up part of the cap and surrounding the valve (2) coincides with the opening (8a) in a ring (8) attached to (the top of) the pipe during rotation (for example, a quarter turn) of the cap (12) bearing the chamber (15) in which the valve (2) is integrated. The inside of the tank connects to the ventilation line, for example connected to a tube (10a) by a quick connector, through the chamber (15). The cap (12), the chamber (15) of cylindrical geometry and the ring (8) are coaxial. Ventilation of the tank (when the cap is on) takes place as indicated by the arrow in FIG. 3b, through the valve (2), the outlet (7) of which is aligned with the tube (10a).

Another possibility, illustrated in FIG. 4, consists in equipping the cap (12) with a by-pass duct (16) that connects the tank and the ventilation line on opening the cap. After rotating the cap, the outlet (17) of the by-pass is aligned with the ventilation line (10). FIG. 4a shows the device in the position providing ventilation of the tank and FIG. 4b in the degassing position at the start of filling.

In another variant, the cap (12) integrating the valve (2) (of which only the exterior is shown) is screwed to an insert (18), possibly welded to the pipe (23).

In the tank ventilation position (FIG. 5a), the vapours pass through the valve (2) by the inlet orifice (9) to rejoin the line (10).

In the degassing position before refilling (FIG. 5b), rotating the cap (12) brings the orifice (19) of the cap opposite the orifice (20) of the insert. The gases may then be discharged via the conduit (10).

FIG. 5c illustrates the situation of degassing while filling. The cap is removed after complete unscrewing and the tip of the nozzle or an attachment (22) required for transfer of the urea solution is introduced into the pipe of the tank. A seal (21) provides leaktightness between the nozzle or filling attachment (22) and the insert (18). The gas volume displaced while filling then passes out via the line (10).

1. A system for storing an ammonia precursor said system comprising a tank, a filler pipe equipped with an obturator and a ventilation line establishing a direct connection between the filler pipe and a gas discharge duct and also a device designed to specifically, open this connection once the obturator starts to be opened.

2. The storage system according to the preceding claim claim 1, wherein the duct for discharging gases leads to a canister capable of adsorbing the ammonia vapours generated in the tank.

3. The storage system according to claim 1, wherein the device comprises a mobile part whose movement is controlled by a specific actuator.

4. The storage system according to claim 3, wherein the obturator is equipped with a locking mechanism comprising an actuator which also controls the movement of the mobile part.

5. The storage system according to claim 1, wherein the ventilation line leads into the top of the filler pipe and is equipped with at least one calibrated valve integrated into the obturator and which is by-passed, once the obturator starts to be opened, by a route automatically connecting the inside of the tank and the ventilation line.

6. The storage system according to claim 5, wherein the by-pass route is integrated into the obturator either completely or partly, the other part then being integrated into an intermediate part attached to the filler pipe.

7. The storage system according to claim 5, wherein the valve is surrounded by a chamber equipped with two orifices leading into the filler pipe: one in the lower part of the chamber and one in its upper part; and wherein the filler pipe also comprises at least two orifices: one (the lower one) borne by an intermediate part and allowing the valve to be by-passed, and the other (the upper one) being the orifice through which the ventilation line leads into the filler pipe, the two lower orifices of the chamber and of the intermediate part respectively possibly being aligned by rotating manually or automatically the obturator from the start of its opening, and the upper orifices of the chamber and of the pipe respectively being aligned or connected both when the obturator is in place, in order to be able to ventilate the tank during operation, and at the start of the obturator's opening, in order to be able to ventilate the tank just before filling.

8. The storage system according to claim 5, wherein the obturator is a cap which integrates the route for by-passing the valve which is activated by a rotational movement of the cap for the purpose of removing it from the pipe.

9. The storage system according to claim 5, wherein the design of the filler pipe and that of the orifice into which the ventilation line leads are such that while the tank is being filled the ventilation is also active.

10. A vehicle equipped with a system for storing an ammonia precursor according to claim 1.

11. The storage system according to claim 7, wherein the intermediate part is a perforated insert or ring.
